(19) United States
(12) Patent Application Publication
(10) Pub. No.: US 2026/0008705 A1
(43) Pub. Date: Jan. 8, 2026

(54) SYSTEM AND METHOD FOR ADVANCED DEFLUORINATION OF WASTEWATER

(71) Applicant: Greentech Environment Co., Ltd., Beijing (CN)

(72) Inventors: Zehua LI, Beijing (CN); Mu LIU, Beijing (CN); Mengyuan DUAN, Beijing (CN); Xikun ZHU, Beijing (CN); Pengchuan ZHANG, Beijing (CN); Liyan ZHANG, Beijing (CN); Kunming SONG, Beijing (CN)

(21) Appl. No.: 19/230,176

(22) Filed: Jun. 6, 2025

(30) Foreign Application Priority Data
Jun. 7, 2024 (CN) 202410733262.2

(51) Int. Cl. C02F 9/00; C02F 1/00; C02F 1/28; C02F 1/42; C02F 1/52; C02F 1/68; C02F 101/14

(52) U.S. Cl. CPC C02F 9/00; C02F 1/006; C02F 1/008; C02F 1/281; C02F 1/42; C02F 2001/422; C02F 2001/5218; C02F 1/68; C02F 2101/14; C02F 2201/005; C02F 2209/06; C02F 2209/40; C02F 2301/046; C02F 2303/16

(57) ABSTRACT

A system for advanced fluorination of wastewater, including a first dosing tank, a second dosing tank, a calcium fluoride crystallizer filled with quartz sand, a fluoride-selective ion exchange column filled with a zirconium-loaded resin, a third dosing tank and a fourth dosing tank are arranged in sequence. A bottom of the calcium fluoride crystallizer is provided with a water distribution plate, which is connected to a first inlet pipe and a return pipe. The fourth dosing tank is configured to store and mix regeneration wastewater. A method for advanced fluorination using such system is also provided.

### CROSS-REFERENCE TO RELATED APPLICATIONS

This application claims the benefit of priority from Chinese Patent Application No. 202410733262.2, filed on Jun. 7, 2024. The content of the aforementioned application, including any intervening amendments made thereto, is incorporated herein by reference in its entirety.

### TECHNICAL FIELD

This application relates to water treatment, and more particularly to a system and method for advanced defluorination of wastewater.

### BACKGROUND

Free fluoride ions are widely found in industrial wastewater (e.g., photovoltaic wastewater), and can form fluoride-based contaminants with other dissolved metal ions. Excessive fluoride in water may adversely affect human health and cause diseases like skeletal fluorosis. Therefore, strict limits must be imposed on the fluoride content in discharged wastewater. According to the Class-1 standards of the national standard “Integrated Wastewater Discharge Standard” (GB 8978-1996), the maximum allowed discharged concentration of fluoride is 10 mg/L. However, with the economic and social development, the fluoride level in the discharged wastewater has been regulated more strictly in some areas. For example, the fluoride concentration limit for the photovoltaic wastewater has been revised to “less than 1 mg/L” in some areas. Therefore, it is urgently needed to develop a reasonable and effective advanced defluorination technique.

Currently, the conventional preliminary fluoride removal primarily employs calcium chloride or calcium hydroxide coagulation-sedimentation method, and zirconium-loaded or aluminum-loaded resins are typically used for fluoride ion exchange to achieve the advanced fluoride removal. However, due to the limited exchange capacity of such resins, the fluoride concentration in the influent must be below 4 ppm to maintain an appropriate regeneration frequency. Unfortunately, the fluoride content in the effluent from the preliminary fluoride removal treatment often fails to meet this requirement. In this regard, an additional pretreatment is usually required before the ion-exchange treatment. A common approach is the addition of a flocculant such as poly-aluminum chloride (PAC). However, the effluent from the primary fluoride removal treatment and conventional pretreatment suffers from a high hardness (greater than 700 ppm), which will lead to clogging of the ion-exchange resin. Moreover, the resin regeneration will be accompanied by the generation of a significant amount of solid waste (primarily calcium fluoride sludge), limiting the practical application of deep fluoride removal technology. Therefore, these issues must be effectively addressed while ensuring a high fluoride removal efficiency.

In view of this, it is urgently needed to develop a simple, readily-controllable and effective system and method for advanced defluorination of wastewater.

### SUMMARY

An object of the disclosure is to provide a system and method for advanced defluorination of wastewater to overcome the defects in the prior art.

Technical solutions of the present disclosure are described as follows.

In a first aspect, this application provides a system for advanced defluorination of wastewater, comprising:
a first dosing tank;
a second dosing tank;
a calcium fluoride crystallizer;
a fluoride-selective ion exchange column;
a third dosing tank; and
a fourth dosing tank;
wherein the first dosing tank, the second dosing tank, the calcium fluoride crystallizer, the fluoride-selective ion exchange column, the third dosing tank and the fourth dosing tank are arranged in sequence;
the calcium fluoride crystallizer is filled with quartz sand; and a bottom of the calcium fluoride crystallizer is provided with a water distribution plate;
the water distribution plate is connected to an end of a first inlet pipe and a first end of a return pipe;
the first inlet pipe is provided with a first inlet pump and a first inlet valve;
the return pipe is provided with a return pump;
an overflow port is provided at a top of the calcium fluoride crystallizer, and is connected to a first end of a second inlet pipe;
the second inlet pipe is provided with a second inlet valve;
a lower portion of the overflow port is connected to a second end of the return pipe;
the fluoride-selective ion exchange column is filled with a zirconium-loaded resin; a top of the fluoride-selective ion exchange column is connected to a second end of the second inlet pipe and a first end of a regeneration wastewater delivery pipe; a bottom of the fluoride-selective ion exchange column is connected to an end of an outlet pipe; and the outlet pipe is provided with an outlet valve;
the first dosing tank is connected to the return pipe through a first dosing pipe; the first dosing pipe is provided with a first dosing pump and a first dosing valve; and the first dosing tank is configured to store a sodium fluoride solution with a first preset concentration a mg/L;
the second dosing tank is connected to the second inlet pipe through a second dosing pipe; the second dosing pipe is provided with a second dosing pump and a second dosing valve; a connection between the second dosing pipe and the second inlet pipe is located at an upstream side of the second inlet valve; and the second dosing tank is configured to store a hydrochloric acid solution with a second preset concentration b mg/L;
the third dosing tank is connected to the outlet pipe through a third dosing pipe; the third dosing pipe is provided with a third dosing pump and a third dosing valve; a connection between the third dosing pipe and the outlet pipe is located at an upstream side of the outlet valve; and the third dosing tank is configured to store a sodium hydroxide solution with a third preset concentration c mg/L;
a second end of the regeneration wastewater delivery pipe is connected to the fourth dosing tank; the fourth dosing tank is connected to the return pipe through a fourth dosing pipe; the fourth dosing pipe is provided with a fourth dosing pump and a fourth dosing valve; and an agitator is provided inside the fourth dosing tank;

In some embodiments, the first inlet pipe is further provided with a first fluoride ion-selective electrode and a calcium ion-selective electrode; and the first fluoride ion-selective electrode and the calcium ion-selective electrode are provided at an upstream side of the first inlet valve;
the second inlet pipe is further provided with a second fluoride ion-selective electrode and a first pH meter; the second fluoride ion-selective electrode is provided at the upstream side of the second inlet valve; and the first pH meter is located between an end of the second dosing pipe and the second inlet valve;
the outlet pipe is further provided with a third fluoride ion-selective electrode and a second pH meter; and the third fluoride ion-selective electrode and the second pH meter are provided at a downstream side of the outlet valve; and
a side wall at a bottom of the fourth dosing tank is provided with a fourth fluoride ion-selective electrode; and a flow meter is provided at an outlet at a bottom of the fourth dosing tank to measure a flow rate of a regeneration wastewater.

In some embodiments, the first preset concentration a is greater than 0 and less than 39,000 mg/L; and/or
the second preset concentration b is greater than 0 and less than 380,000 mg/L; and/or
the third preset concentration c is greater than 0 and less than 520,000 mg/L.

In a second aspect, this application provides a method for advanced defluorination of wastewater using the system provided herein, comprising:
(S1) activating the first inlet pump, the return pump, the first dosing pump and the second dosing pump, and opening the first inlet valve, the first dosing valve, the second inlet valve, the second dosing valve, and the outlet valve; and keeping the third dosing pump, the fourth dosing pump and the agitator in an idle state, and keeping the third dosing valve and the fourth dosing valve in a closed state;
introducing a preliminarily-defluorinated wastewater generated by coagulation-precipitation treatment into the calcium fluoride crystallizer through the first inlet pipe and the water distribution plate at a first preset flow rate Q1 m³/h, wherein the quartz sand inside the calcium fluoride crystallizer forms a fluidized bed to adsorb calcium fluoride crystals; and
partially returning an effluent above the fluidized bed to the water distribution plate through the return pipe at a preset return ratio;
(S2) measuring, by the first fluoride ion-selective electrode, a fluoride content of the preliminarily-defluorinated wastewater as f₁ mg/L; measuring, by the calcium ion-selective electrode, a calcium ion content of the preliminarily-defluorinated wastewater as K mg/L; and feeding the sodium fluoride solution from the first dosing tank into the return pipe at a second preset flow rate q₂ m³/h, wherein

$${q}_{2} = \frac{{Q}_{1} ( 0.95 K - f 1 )}{a} ,$$

(S3) after a first preset hydraulic retention time HRT1 (h), allowing the effluent from the overflow port of the calcium fluoride crystallizer to flow through the second inlet pipe into the fluoride-selective ion exchange column for contact with the zirconium-loaded resin over a second preset hydraulic retention time HRT2 (h), followed by discharge through the outlet pipe; and feeding the hydrochloric acid solution from the second dosing tank into the second inlet pipe at a third preset flow rate q₃ m³/h, wherein

$${q}_{3} = \frac{160 {Q}_{1}}{b} ;$$

(S4) after the second preset hydraulic retention time HRT2 (h), activating the third dosing pump and opening the third dosing valve; and feeding the sodium hydroxide solution from the third dosing tank into the outlet pipe at a fourth preset flow rate q₄ m³/h, wherein

$${q}_{4} = \frac{175 {Q}_{1}}{c} ;$$

and
(S5) measuring, by the second fluoride ion-selective electrode, a fluoride content of the effluent from the calcium fluoride crystallizer as f₂ mg/L; and measuring, by the third fluoride ion-selective electrode, a fluoride content of an effluent from an outlet valve as f₃ mg/L.

In some embodiments, when f₂ is greater than or equal to 4 mg/L, stopping the first dosing pump, the second dosing pump, the first inlet pump and the return pump, and closing the first dosing valve, the second dosing valve, the first inlet valve, and the second inlet valve; after the second preset hydraulic retention time HRT₂ (h), stopping the third dosing pump and closing the third dosing valve, emptying the calcium fluoride crystallizer and filling the calcium fluoride crystallizer with the quartz sand; and manually repeating steps S1-S5.

In some embodiments, when f₃ is greater than or equal to 1 mg/L, stopping all pumps except for the third dosing pump, and closing all valves except for the third dosing valve and the outlet valve; after the second preset hydraulic retention time HRT₂ (h), closing the outlet valve, and proceeding to steps S6-S8;
(S6) within a preset regeneration time DT (h), feeding the sodium hydroxide solution from the third dosing tank into the outlet pipe at a fifth preset flow rate q₅ m³/h; directing the sodium hydroxide solution into the fluoride-selective ion exchange column through the outlet pipe to desorb fluoride ions from the zirconium-loaded resin, and transferring the regeneration wastewater into the fourth dosing tank through the regeneration wastewater delivery pipe;
wherein

$${q}_{5} = \frac{36 \times {10}^{5} \times {HRT}_{2} \times {Q}_{1}}{c \times DT} ;$$

(S7) after the preset regeneration time DT (h), switching the third dosing pump from forward rotation to reverse rotation, and activating the agitator to stir the regeneration wastewater in the fourth dosing tank; and measuring, by the fourth fluoride ion-selective electrode, a fluoride content of the regeneration wastewater as f₄ mg/L; and
(S8) after one-third of the preset regeneration time DT (h), switching the third dosing pump from the reverse rotation to the forward rotation, and automatically repeating steps S1-S5.

In some embodiments, the method further comprises:
in a case that the fluoride content f₂ is less than 4 mg/L, the fluoride content f₃ is less than 1 mg/L, and the flow meter does not perform an empty-pipe alarm, activating the fourth dosing pump and opening the fourth dosing valve; and feeding the regeneration wastewater from the fourth dosing tank into the return pipe at a sixth preset flow rate q₆ m³/h, wherein

$${q}_{6} = \frac{r \times {Q}_{1} \times {f}_{1}}{{f}_{4}} ,$$

and r is a dimensionless coefficient greater than 1;
in a case that the fluoride content f₂ is less than 4 mg/L, the fluoride content f₃ is less than 1 mg/L, and the flow meter does not perform the empty-pipe alarm, feeding the sodium fluoride solution from the first dosing tank into the return pipe at a seventh preset flow rate q₇ m³/h;
wherein

$${q}_{7} = \frac{{Q}_{1} ( 0.95 K - {f}_{1} )}{a} - {q}_{6} ;$$

and
in a case that the fluoride content f₂ is less than 4 mg/L, the fluoride content f₃ is less than 1 mg/L, and the flow meter performs the empty-pipe alarm, stopping the fourth dosing pump and closing the fourth dosing valve, and feeding the sodium fluoride solution from the first dosing tank into the return pipe at the second preset flow rate q₂ m³/h.

In some embodiments, in response to a case that a reading of the first pH meter is greater than or equal to 3, increasing q₃ by a preset increment; in response to a case that the reading of the first pH meter is less than or equal to 2, decreasing q₃ by a preset decrement; and in response to a case that the reading of the first pH meter is greater than 2 and less than 3, maintaining q₃ at its current value.

In some embodiments, in response to a case that a reading of the second pH meter is less than or equal to 6, increasing q₄ by a preset increment; in response to a case that the reading of the second pH meter is greater than or equal to 9, decreasing q₄ by a preset decrement; and in response to a case that the reading of the second pH meter is greater than 6 and less than 9, maintaining q₄ at its current value.

In some embodiments, the second preset hydraulic retention time HRT₂(h) is

$$\frac{1}{30} - \frac{1}{20} h .$$

Compared to the prior art, the present disclosure has the following beneficial effects.

In the present disclosure, the system and method for advanced defluorination of wastewater enable complete recovery and reuse of the regeneration waste liquid from the fluoride-selective ion exchange resin. The fluoride ions, which would otherwise be converted into solid waste, are instead used as supplementary reactants for the calcium fluoride crystallization reaction, thereby reducing the consumption of sodium fluoride chemicals and fully eliminating the costs associated with regeneration waste treatment and solid waste disposal.

The system provided herein achieves simultaneous defluorination and hardness removal without the use of dedicated hardness-removal resins, thereby effectively preventing clogging of the fluoride-selective ion exchange resin, increasing the exchange capacity of the fluoride-selective ion exchange resin and extending its regeneration cycle, while further improving the quality of the effluent water.

The system provided herein is characterized by integrated automatic control, ease of operation and high feasibility.

### BRIEF DESCRIPTION OF THE DRAWINGS

The accompanying drawings are provided to facilitate the understanding of the technical solutions of the present disclosure, and form a part of the specification to illustrate the disclosure together with the embodiments. The accompanying drawings are illustrative and exemplary, and are not intended to limit the disclosure.

In order to illustrate the technical solutions in the embodiments of the present disclosure or the prior art more clearly, the accompanying drawings needed in the description of the embodiments or prior art will be briefly described below. Obviously, presented in the accompanying drawings are only some embodiments of the present disclosure, and for those of ordinary skill in the art, other accompanying drawings can be obtained from the structures illustrated therein without making creative effort.

FIG. 1 is a structural diagram of a system for advanced defluorination of wastewater according to an embodiment of the present disclosure.

### DETAILED DESCRIPTION OF EMBODIMENTS

To facilitate the understanding of the objectives, features, and advantages of the present disclosure, the disclosure will be described in detail below with reference to embodiments and accompanying drawings. It should be noted that the embodiments of the present disclosure and the features therein may be combined in the absence of contradiction.

Many specific details are provided below to facilitate a comprehensive understanding of the present disclosure. However, it should be noted that the disclosure may be implemented in ways other than those explicitly described herein. It is obvious that described herein are merely some embodiments of the present disclosure, instead of all embodiments.

### Example 1

Provided herein is a system for advanced defluorination of wastewater, including a first dosing tank, a second dosing tank, a calcium fluoride crystallizer, a fluoride-selective ion exchange column, a third dosing tank and a fourth dosing tank. The first dosing tank, the second dosing tank, the calcium fluoride crystallizer, the fluoride-selective ion exchange column, the third dosing tank and the fourth dosing tank are arranged in sequence. The calcium fluoride crystallizer is filled with quartz sand. A bottom of the calcium fluoride crystallizer is provided with a water distribution plate. The water distribution plate is connected to an end of a first inlet pipe and a first end of a return pipe. The first inlet pipe is provided with a first inlet pump and a first inlet valve. The return pipe is provided with a return pump. An overflow port is provided at a top of the calcium fluoride crystallizer, and is connected to a first end of a second inlet pipe. The second inlet pipe is provided with a second inlet valve. A lower portion of the overflow port is connected to a second end of the return pipe.

The fluoride-selective ion exchange column is filled with a zirconium-loaded resin. A top of the fluoride-selective ion exchange column is connected to a second end of the second inlet pipe and a first end of a regeneration wastewater delivery pipe. A bottom of the fluoride-selective ion exchange column is connected to an end of an outlet pipe. The outlet pipe is provided with an outlet valve.

The first dosing tank is connected to the return pipe through a first dosing pipe. The first dosing pipe is provided with a first dosing pump and a first dosing valve. The first dosing tank is configured to store a sodium fluoride solution with a first preset concentration a mg/L, where the first preset concentration a is greater than 0 and less than 39,000 mg/L.

The second dosing tank is connected to the second inlet pipe through a second dosing pipe. The second dosing pipe is provided with a second dosing pump and a second dosing valve. A connection between the second dosing pipe and the second inlet pipe is located at an upstream side of the second inlet valve. The second dosing tank is configured to store a hydrochloric acid solution with a second preset concentration b mg/L, where the second preset concentration b is greater than 0 and less than 380,000 mg/L.

The third dosing tank is connected to the outlet pipe through a third dosing pipe. The third dosing pipe is provided with a third dosing pump and a third dosing valve. A connection between the third dosing pipe and the outlet pipe is located at an upstream side of the outlet valve. The third dosing tank is configured to store a sodium hydroxide solution with a third preset concentration c mg/L, where the third preset concentration c is greater than 0 and less than 520,000 mg/L.

A second end of the regeneration wastewater delivery pipe is connected to the fourth dosing tank. The fourth dosing tank is connected to the return pipe through a fourth dosing pipe. The fourth dosing pipe is provided with a fourth dosing pump and a fourth dosing valve. An agitator is provided inside the fourth dosing tank.

The first inlet pipe is further provided with a first fluoride ion-selective electrode and a calcium ion-selective electrode. The first fluoride ion-selective electrode and the calcium ion-selective electrode are provided at an upstream side of the first inlet valve.

The second inlet pipe is further provided with a second fluoride ion-selective electrode and a first pH meter. The second fluoride ion-selective electrode is provided at the upstream side of the second inlet valve. The first pH meter is located between tail end of the second dosing pipe and the second inlet valve.

The outlet pipe is further provided with a third fluoride ion-selective electrode and a second pH meter. The third fluoride ion-selective electrode and the second pH meter are provided at a downstream side of the outlet valve.

A side wall at a bottom of the fourth dosing tank is provided with a fourth fluoride ion-selective electrode. A flow meter is provided at an outlet at a bottom of the fourth dosing tank to measure a flow rate of a regeneration wastewater.

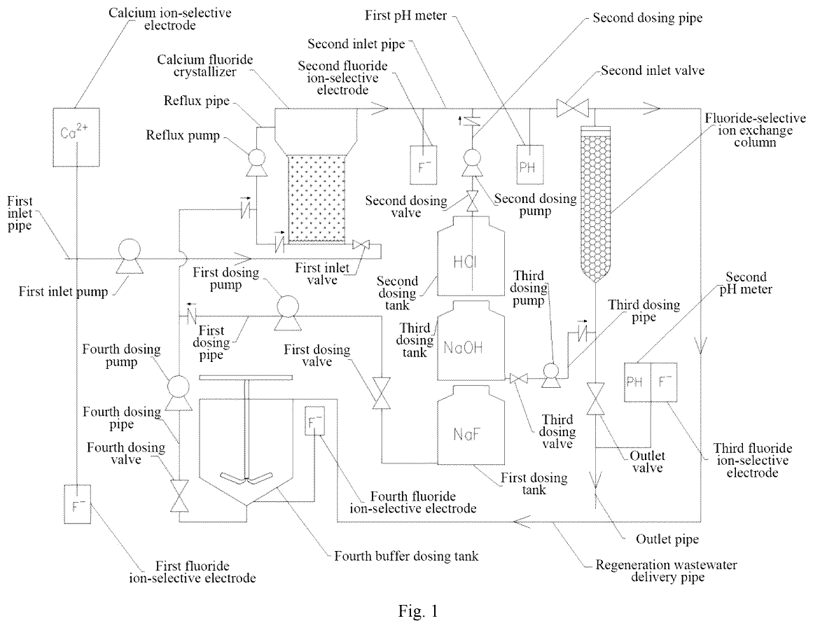

In this embodiment, as shown in FIG. 1, the tail end of the return pipe, the tail end of the first dosing pipe, the tail end of the second dosing pipe, and the tail end of the fourth dosing pipe are each provided with a check valve (the pipe tail end is determined according to the water or chemical delivery direction).

In some embodiments, the third dosing pump is a reversibly operable pump, including but not limited to a screw pump, a piston pump, or a peristaltic pump.

In some embodiments, a regeneration process of the zirconium-loaded resin is carried out in three batches, in which each batch uses an equal amount of sodium hydroxide solution; the first batch desorbs more than 50% of the fluoride ions, the second batch removes most of the remaining fluoride ions, and the third batch performs a safety rinse and recovery.

### Example 2

Provided herein is a method for advanced defluorination of wastewater using the system of Example 1, including the following steps.
(S1) The first inlet pump, the return pump, the first dosing pump and the second dosing pump are activated. The first inlet valve, the first dosing valve, the second inlet valve, the second dosing valve and the outlet valve are opened. The third dosing pump, the fourth dosing pump and the agitator are kept in an idle state. The third dosing valve and the fourth dosing valve are kept in a closed state. A preliminarily-defluorinated wastewater generated by coagulation-precipitation treatment is introduced into the calcium fluoride crystallizer through the first inlet pipe and the water distribution plate at a first preset flow rate Q₁ m³/h, where the quartz sand inside the calcium fluoride crystallizer forms a fluidized bed to adsorb calcium fluoride crystals. An effluent above the fluidized bed is partially returned to the water distribution plate through the return pipe at a preset return ratio.
(S2) A fluoride content of the preliminarily-defluorinated wastewater is measured by the first fluoride ion-selective electrode as f₁ mg/L. A calcium ion content of the preliminarily-defluorinated wastewater is measured by the calcium ion-selective electrode as K mg/L. The sodium fluoride solution is fed from the first dosing tank into the return pipe at a second preset flow rate q₂ m³/h, where

$${q}_{2} = \frac{{Q}_{1} ( 0.95 K - f 1 )}{a} .$$

(S3) After a first preset hydraulic retention time HRT₁ (h), the effluent from the overflow port of the calcium fluoride crystallizer is allowed to flow through the second inlet pipe into the fluoride-selective ion exchange column for contact with the zirconium-loaded resin over a second preset hydraulic retention time HRT₂ (h), and discharged through the outlet pipe. The hydrochloric acid solution is fed from the second dosing tank into the second inlet pipe at a third preset flow rate q₃ m³/h, where

$${q}_{3} = \frac{160 {Q}_{1}}{b} .$$

$${q}_{3} ( {m}^{3} / h ) = \frac{160 mg / L \times {Q}_{1} {m}^{3} / h}{b mg / L} ,$$

Specifically, where 160 mg/L represents the 100% HCl dosage required to adjust the pH of the effluent from the overflow port of the calcium fluoride crystallizer to flow through the second inlet pipe into the fluoride-selective ion exchange column, as determined by experimental experience, with both sides of the equation having the same units.
(S4) After the second preset hydraulic retention time HRT₂ (h), the third dosing pump is activated and the third dosing valve is opened. The sodium hydroxide solution is fed from the third dosing tank into the outlet pipe at a fourth preset flow rate q₄ m³/h, where

$${q}_{4} = \frac{175 {Q}_{1}}{c} .$$

Specifically,

$${q}_{4} ( {m}^{3} / h ) = \frac{175 mg / L \times {Q}_{1} {m}^{3} / h}{c mg / L} ,$$

where 175 mg/L is the 100% NaOH dosage required to adjust the pH of the effluent from the fluoride-selective ion exchange column, based on experimental experience, with the units on both sides of the equation being consistent.

In some embodiments, a bed flow rate of the zirconium-loaded resin is 10-15 BV/h, i.e., a ratio of Q₁ to V is 10-15, where V (m³) is a total volume of the resin, including both the resin particles and the pores between the particles.

In some embodiments, with the zirconium-loaded resin having a porosity of 50%, the second hydraulic retention time HRT₂ is given by

$${HRT}_{2} = \frac{0.5 V}{{Q}_{1}} = \frac{1}{30} - \frac{1}{20} h .$$

(S5) A fluoride content of the effluent from the calcium fluoride crystallizer is measured as f₂ mg/L by the second fluoride ion-selective electrode. A fluoride content of an effluent from an outlet valve is measured as f₃ mg/L by the third fluoride ion-selective electrode.

When f₂ is greater than or equal to 4 mg/L, the first dosing pump, the second dosing pump, the first inlet pump and the return pump are stopped, and the first dosing valve, the second dosing valve, the first inlet valve, and the second inlet valve are closed. After the second preset hydraulic retention time HRT₂ (h), the third dosing pump is stopped and the third dosing valve is closed, the calcium fluoride crystallizer is emptied and filled with the quartz sand. Steps S1-S5 are manually repeated.

When f₃ is greater than or equal to 1 mg/L, all pumps except for the third dosing pump are stopped. All valves except for the third dosing valve and the outlet valve are closed. After the second preset hydraulic retention time HRT₂ (h), the outlet valve is closed, and steps S6-S8 are carried out.
(S6) Within a preset regeneration time DT (h), the sodium hydroxide solution from the third dosing tank is fed into the outlet pipe at a fifth preset flow rate q₅ m³/h. The sodium hydroxide solution is directed into the fluoride-selective ion exchange column through the outlet pipe to desorb fluoride ions from the zirconium-loaded resin, and the regeneration wastewater is transferred into the fourth dosing tank through the regeneration wastewater delivery pipe.

Specifically,

$$\begin{matrix}{q}_{5} {m}^{3} / h = \frac{\frac{\frac{( 2 \times {HRT}_{2} \times Q 1 ) {m}^{3} \times 1000 \times 60 g / L \times 1000}{c mg / L}}{1000}}{\frac{DT}{3} h} \\ = \frac{3.6 \times {10}^{5} \times {HRT}_{2} \times {Q}_{1}}{c \times DT} ,\end{matrix}$$

where 60 g/L represents a ratio of the effective mass of sodium hydroxide to a total volume of the zirconium-loaded resin for each batch during regeneration, as determined based on experimental experience, with the units on both sides of the equation being consistent.

After the preset regeneration time DT (h), the third dosing pump is switched from forward rotation to reverse rotation, and the agitator is activated to stir the regeneration wastewater in the fourth dosing tank. A fluoride content of the regeneration wastewater is measured as f₄ mg/L by the fourth fluoride ion-selective electrode.

After one-third of the preset regeneration time DT (h), the third dosing pump is switched from the reverse rotation to the forward rotation, and steps S1-S5 are automatically repeated.

In a case that the fluoride content f₂ is less than 4 mg/L, the fluoride content f₃ is less than 1 mg/L, and the flow meter does not perform an empty-pipe alarm, the fourth dosing pump is activated and the fourth dosing valve is opened. The regeneration wastewater from the fourth dosing tank is fed into the return pipe at a sixth preset flow rate q₆ m³/h.

In some embodiments, the regeneration wastewater in the fourth dosing tank serves as a fluoride ion supplement for the influent to the calcium fluoride crystallizer, i.e., if

$$\frac{{f}_{4} \times {q}_{6}}{{Q}_{1}} > {f}_{1} , then {q}_{6} > \frac{{Q}_{1} \times {f}_{1}}{{f}_{4}} , where {q}_{6} = \frac{r \times {Q}_{1} \times {f}_{1}}{{f}_{4}}$$

and r is a dimensionless coefficient greater than 1.

In a case that the fluoride content f₂ is less than 4 mg/L, the fluoride content f₃ is less than 1 mg/L, and the flow meter does not perform the empty-pipe alarm, the sodium fluoride solution from the first dosing tank is fed into the return pipe at a seventh preset flow rate q₇ m³/h, in which

$${q}_{7} = \frac{{Q}_{1} ( 0.95 K - {f}_{1} )}{a} - {q}_{6} .$$

In a case that the fluoride content f₂ is less than 4 mg/L, the fluoride content f₃ is less than 1 mg/L, and the flow meter performs the empty-pipe alarm, the fourth dosing pump is stopped, the fourth dosing valve is closed, and the sodium fluoride solution from the first dosing tank is fed into the return pipe at the second preset flow rate q₂ m³/h.

When a reading of the first pH meter is greater than or equal to 3, the third preset flow rate q₃ is increased by a preset increment. When the reading of the first pH meter is less than or equal to 2, the third preset flow rate q₃ is decreased by a preset decrement. When the reading of the first pH meter is greater than 2 and less than 3, the third preset flow rate q₃ is maintained at its current value. When a reading of the second pH meter is less than or equal to 6, the fourth preset flow rate q₄ is increased by a preset increment. When the reading of the second pH meter is greater than or equal to 9, the fourth preset flow rate q₄ is decreased by a preset decrement. When the reading of the second pH meter is greater than 6 and less than 9, the fourth preset flow rate q₄ is maintained at its current value.

### Experimental Example

The same batch of newly manufactured zirconium-loaded resin was used to treat the effluent from the same preliminary fluoride removal unit at a bed velocity of 13 BV/h (an influent flow rate of 65 L/h and a total zirconium-loaded resin volume of 5 L), with and without the treatment method provided herein, respectively. The results were shown in Table 1 and Table 2.

TABLE 1
Operating conditions of fluoride-selective ion exchange
column without using the method of the present disclosure

| | | | | pH of |
|---|---|---|---|---|
| | Fluoride content of | Fluoride content of | pH of influent | effluent from |
| | influent to fluoride- | effluent from | to fluoride- | fluoride- |
| Operating | selective ion | fluoride-selective | selective ion | selective ion |
| time | exchange column | ion exchange | exchange | exchange |
| (h) | (mg/L) | column (mg/L) | column | column |
| 3 | 4.99 | 0.69 | 2.9 | 2.8 |
| 11 | 5.09 | 0.69 | 2.5 | 2.8 |
| 14 | 5.26 | 1.01 | 2.4 | 2.7 |
| 23 | 4.74 | 0.68 | 2.0 | 3.7 |
| 25 | 4.63 | 0.88 | 1.4 | 2.8 |
| 34 | 3.79 | 0.89 | 2.4 | 2.8 |
| 40 | 7.4 | 0.93 | 2.1 | 3.0 |
| 47 | 6.63 | 1.26 | 2.2 | 3.1 |

TABLE 2
Operating conditions of fluoride-selective ion exchange
column using the method of the present disclosure

| | | | | pH of |
|---|---|---|---|---|
| | Fluoride content | Fluoride content of | pH of influent | effluent from |
| | of influent to | effluent from | to fluoride- | fluoride- |
| | fluoride-selective | fluoride-selective | selective ion | selective ion |
| Operating | ion exchange | ion exchange | exchange | exchange |
| time (h) | column (mg/L) | column (mg/L) | column | column |
| 12 | 2.92 | 0.41 | 2.6 | 2.7 |
| 24 | 2.55 | 0.63 | 2.5 | 3.3 |
| 36 | 3.07 | 0.3 | 2.7 | 2.5 |
| 48 | 2.42 | 0.25 | 2.6 | 2.6 |
| 60 | 2.83 | 0.23 | 2.7 | 2.6 |
| 72 | 3.12 | 0.18 | 2.8 | 2.8 |
| 84 | 3.08 | 0.2 | 2.8 | 2.8 |
| 96 | 2.87 | 0.2 | 2.7 | 2.6 |

According to Table 1 and Table 2, when the method provided herein was not used, the pH of the influent and effluent of the fluoride-selective ion exchange column fluctuated significantly, and the regeneration cycle was less than 48 h. Under the condition that the effluent fluoride content did not exceed 1 mg/L, the exchange capacity was less than 2.7 g F/L of resin. When the method provided herein was used, the pH of the influent and effluent of the fluoride-selective ion exchange column was relatively stable, and the regeneration cycle was greater than 96 h. Under the condition that the effluent fluoride content did not exceed 1 mg/L, the exchange capacity was greater than 3.1 g F/L of resin.

When the method provided herein was not used, 30 L of 3% sodium hydroxide solution was required for each regeneration of the zirconium-loaded resin, of which 10 L could be recovered and reused. Therefore, 20 L of regeneration waste liquid was produced each time. With a regeneration cycle of 48 h, approximately 20 L of regeneration waste liquid was generated for every 3.12 tons of water produced. As a result, when the method provided herein was not used, the cost of treating the regeneration waste liquid was approximately 0.062 yuan/ton of produced water. However, when the method provided herein was used, no treatment of the regeneration waste liquid was required, and the cost of treating the regeneration waste liquid was 0.

TABLE 3
Accounting of regeneration waste liquid treatment cost

| | Dosage for | | Agent consumption |
|---|---|---|---|
| pH of | neutralizing | Price | for neutralizing |
| regeneration | regeneration | of 37% | regeneration waste |
| waste liquid | waste liquid | HCl | liquid |
| 12.0 | 2.340 g HCl/ton of | 400 yuan/ton | 0.003 yuan/ton of |
| | produced water | | produced water |

| | Dosage for | | Agent consumption |
|---|---|---|---|
| Fluoride content | removing fluoride | Price | for removing fluoride |
| of regeneration | from regeneration | of 100% | from regeneration |
| waste liquid | waste liquid | CaCl₂ | waste liquid |
| 570 ppm | 21.35 g CaCl₂/ton | 2500 yuan/ton | 0.053 yuan/ton of |
| | of produced water | | produced water |

| | Price of | Consumption |
|---|---|---|
| Output of | disposing | of solid |
| solid waste | solid waste | waste disposal |
| 15.00 g CaF₂/ | 400 yuan/ton | 0.006 yuan/ton of |
| ton of water | | produced water |

| Total | 0.062 yuan/ton of |
|---|---|
| | produced water |

It should be noted that, as used herein, terms such as “first” and “second” are only descriptive, and should not be construed as indicating or implying their relative importance or implicitly specifying the number of technical features indicated. Moreover, the terms “comprise”, “include” or any other variants thereof are intended to cover non-exclusive inclusion, such that a process, method, article, or apparatus that comprises a list of elements does not include only those elements, but may also include other elements not expressly listed or elements inherent to such process, method, article, or apparatus. In the absence of additional limitations, an element defined by the phrase “comprising a . . . ” does not exclude the presence of additional elements of the same type in a process, method, article, or apparatus that comprises the stated element.

Described embodiments are merely illustrative, and are not intended to limit the scope of the present disclosure. It should be understood that various modifications, changes and replacements made by those skilled in the art without departing from the spirit of the disclosure shall fall within the scope of the present disclosure defined by the appended claims.

1. A system for advanced defluorination of wastewater, comprising:
a first dosing tank;
a second dosing tank;
a calcium fluoride crystallizer;
a fluoride-selective ion exchange column;
a third dosing tank; and
a fourth dosing tank;
wherein the first dosing tank, the second dosing tank, the calcium fluoride crystallizer, the fluoride-selective ion exchange column, the third dosing tank and the fourth dosing tank are arranged in sequence;
the calcium fluoride crystallizer is filled with quartz sand; and a bottom of the calcium fluoride crystallizer is provided with a water distribution plate;
the water distribution plate is connected to an end of a first inlet pipe and a first end of a return pipe;
the first inlet pipe is provided with a first inlet pump and a first inlet valve;
the return pipe is provided with a return pump;
an overflow port is provided at a top of the calcium fluoride crystallizer, and is connected to a first end of a second inlet pipe;
the second inlet pipe is provided with a second inlet valve;
a lower portion of the overflow port is connected to a second end of the return pipe;
the fluoride-selective ion exchange column is filled with a zirconium-loaded resin; a top of the fluoride-selective ion exchange column is connected to a second end of the second inlet pipe and a first end of a regeneration wastewater delivery pipe; a bottom of the fluoride-selective ion exchange column is connected to an end of an outlet pipe; and the outlet pipe is provided with an outlet valve;
the first dosing tank is connected to the return pipe through a first dosing pipe; the first dosing pipe is provided with a first dosing pump and a first dosing valve; and the first dosing tank is configured to store a sodium fluoride solution with a first preset concentration a mg/L;
the second dosing tank is connected to the second inlet pipe through a second dosing pipe; the second dosing pipe is provided with a second dosing pump and a second dosing valve; a connection between the second dosing pipe and the second inlet pipe is located at an upstream side of the second inlet valve; and the second dosing tank is configured to store a hydrochloric acid solution with a second preset concentration b mg/L;
the third dosing tank is connected to the outlet pipe through a third dosing pipe; the third dosing pipe is provided with a third dosing pump and a third dosing valve; a connection between the third dosing pipe and the outlet pipe is located at an upstream side of the outlet valve; and the third dosing tank is configured to store a sodium hydroxide solution with a third preset concentration c mg/L;
a second end of the regeneration wastewater delivery pipe is connected to the fourth dosing tank; the fourth dosing tank is connected to the return pipe through a fourth dosing pipe; the fourth dosing pipe is provided with a fourth dosing pump and a fourth dosing valve; and an agitator is provided inside the fourth dosing tank;
the first inlet pipe is further provided with a first fluoride ion-selective electrode and a calcium ion-selective electrode; and the first fluoride ion-selective electrode and the calcium ion-selective electrode are provided at an upstream side of the first inlet valve;
the second inlet pipe is further provided with a second fluoride ion-selective electrode and a first pH meter; the second fluoride ion-selective electrode is provided at the upstream side of the second inlet valve; and the first pH meter is located between an end of the second dosing pipe and the second inlet valve;
the outlet pipe is further provided with a third fluoride ion-selective electrode and a second pH meter; and the third fluoride ion-selective electrode and the second pH meter are provided at a downstream side of the outlet valve; and
a side wall at a bottom of the fourth dosing tank is provided with a fourth fluoride ion-selective electrode; and a flow meter is provided at an outlet at a bottom of the fourth dosing tank to measure a flow rate of a regeneration wastewater.

2. The system according to claim 1, wherein the first preset concentration a is greater than 0 and less than 39,000 mg/L;
the second preset concentration b is greater than 0 and less than 380,000 mg/L; and
the third preset concentration c is greater than 0 and less than 520,000 mg/L.

3. A method for advanced defluorination of wastewater using the system according to claim 1, comprising:
(S1) activating the first inlet pump, the return pump, the first dosing pump and the second dosing pump, and opening the first inlet valve, the first dosing valve, the second inlet valve, the second dosing valve, and the outlet valve; and keeping the third dosing pump, the fourth dosing pump and the agitator in an idle state, and keeping the third dosing valve and the fourth dosing valve in a closed state;
introducing a preliminarily-defluorinated wastewater generated by coagulation-precipitation treatment into the calcium fluoride crystallizer through the first inlet pipe and the water distribution plate at a first preset flow rate Q₁ m³/h, wherein the quartz sand inside the calcium fluoride crystallizer forms a fluidized bed to adsorb calcium fluoride crystals; and
partially returning an effluent above the fluidized bed to the water distribution plate through the return pipe at a preset return ratio;
(S2) measuring, by the first fluoride ion-selective electrode, a fluoride content of the preliminarily-defluorinated wastewater as f₁ mg/L; measuring, by the calcium ion-selective electrode, a calcium ion content of the preliminarily-defluorinated wastewater as K mg/L; and feeding the sodium fluoride solution from the first dosing tank into the return pipe at a second preset flow rate q₂ m³/h, wherein
$${q}_{2} = \frac{{Q}_{1} ( 0.95 K - f 1 )}{a} ;$$
(S3) after a first preset hydraulic retention time HRT₁ (h), allowing the effluent from the overflow port of the calcium fluoride crystallizer to flow through the second inlet pipe into the fluoride-selective ion exchange column for contact with the zirconium-loaded resin over a second preset hydraulic retention time HRT₂ (h), followed by discharge through the outlet pipe; and feeding the hydrochloric acid solution from the second dosing tank into the second inlet pipe at a third preset flow rate q₃ m³/h, wherein
$${q}_{3} = \frac{160 {Q}_{1}}{b} ;$$
(S4) after the second preset hydraulic retention time HRT₂ (h), activating the third dosing pump and opening the third dosing valve; and feeding the sodium hydroxide solution from the third dosing tank into the outlet pipe at a fourth preset flow rate q₄ m³/h, wherein
$${q}_{4} = \frac{175 {Q}_{1}}{c} ;$$
and
(S5) measuring, by the second fluoride ion-selective electrode, a fluoride content of the effluent from the calcium fluoride crystallizer as f₂ mg/L; and measuring, by the third fluoride ion-selective electrode, a fluoride content of an effluent from an outlet valve as f₃ mg/L.

4. The method according to claim 3, further comprising:
when f₂ is greater than or equal to 4 mg/L, stopping the first dosing pump, the second dosing pump, the first inlet pump and the return pump, and closing the first dosing valve, the second dosing valve, the first inlet valve, and the second inlet valve;
after the second preset hydraulic retention time HRT₂ (h), stopping the third dosing pump and closing the third dosing valve, emptying the calcium fluoride crystallizer and filling the calcium fluoride crystallizer with the quartz sand; and manually repeating steps S1-S5.

5. The method according to claim 4, further comprising:
when f₃ is greater than or equal to 1 mg/L, stopping all pumps except for the third dosing pump, and closing all valves except for the third dosing valve and the outlet valve; after the second preset hydraulic retention time HRT₂ (h), closing the outlet valve, and proceeding to steps S6-S8;
(S6) within a preset regeneration time DT (h), feeding the sodium hydroxide solution from the third dosing tank into the outlet pipe at a fifth preset flow rate q₅ m³/h;
directing the sodium hydroxide solution into the fluoride-selective ion exchange column through the outlet pipe to desorb fluoride ions from the zirconium-loaded resin, and transferring the regeneration wastewater into the fourth dosing tank through the regeneration wastewater delivery pipe;
wherein
$${q}_{5} = \frac{3.6 \times {10}^{5} \times {HRT}_{2} \times {Q}_{1}}{c \times D T} ;$$
(S7) after the preset regeneration time DT (h), switching the third dosing pump from forward rotation to reverse rotation, and activating the agitator to stir the regeneration wastewater in the fourth dosing tank; and measuring, by the fourth fluoride ion-selective electrode, a fluoride content of the regeneration wastewater as f₄ mg/L; and
(S8) after one-third of the preset regeneration time DT (h), switching the third dosing pump from the reverse rotation to the forward rotation, and automatically repeating steps S1-S5.

6. The method according to claim 4, further comprising:
in a case that the fluoride content f₂ is less than 4 mg/L, the fluoride content f₃ is less than 1 mg/L, and the flow meter does not perform an empty-pipe alarm, activating the fourth dosing pump and opening the fourth dosing valve; and feeding the regeneration wastewater from the fourth dosing tank into the return pipe at a sixth preset flow rate q₆ m³/h, wherein
$${q}_{6} = \frac{r \times {Q}_{1} \times {f}_{1}}{{f}_{4}} ,$$
and r is a dimensionless coefficient greater than 1;
in a case that the fluoride content f₂ is less than 4 mg/L, the fluoride content f₃ is less than 1 mg/L, and the flow meter does not perform the empty-pipe alarm, feeding the sodium fluoride solution from the first dosing tank into the return pipe at a seventh preset flow rate q₇ m³/h;
wherein
$${q}_{7} = \frac{{Q}_{1} ( 0.95 K - {f}_{1} )}{a} - {q}_{6} ;$$
and
in a case that the fluoride content f₂ is less than 4 mg/L, the fluoride content f₃ is less than 1 mg/L, and the flow meter performs the empty-pipe alarm, stopping the fourth dosing pump and closing the fourth dosing valve, and feeding the sodium fluoride solution from the first dosing tank into the return pipe at the second preset flow rate q₂ m³/h.

7. The method according to claim 3, wherein the second preset hydraulic retention time HRT₂ (h) is
$$\frac{1}{30} - \frac{1}{20} h .$$
